(19) United States
(12) Patent Application Publication
(10) Pub. No.: US 2008/0083313 A1
(43) Pub. Date: Apr. 10, 2008

(54) Circular-saw elevaging and lowering device for a table saw

(76) Inventor: Bor-Yann Chuang, Taiping City (TW)

Correspondence Address: BRUCE H. TROXELL, SUITE 1404, 5205 LEESBURG PIKE, FALLS CHURCH, VA, 22041, US

(21) Appl. No.: 11/518,420

(22) Filed: Sep. 11, 2006

(51) Int. Cl. B23D 19/00

(52) U.S. Cl. 83/473

(57) ABSTRACT

A circular-saw elevating and lowering device for a table saw includes a main rod, a worm and a moving up-and-down block. The main rod is pivotally connected in a saw base pivotally connected in a base of the table saw, and a main bevel gear fixed on an end of the main rod. The worm has one end pivotally connected to the saw base, and the other end fixed with a subordinate bevel gear engaging with the main bevel gear. Further, the moving up-and-down block is threadably combined with the worm, which has its upper end fixed with a separating plate and its front end fixed with a circular saw unit. When the main rod is rotated, both the circular saw unit and the separating plate can be moved up or down synchronously, with the gap between the saw unit and the separating unit always kept the same.

### BACKGROUND OF THE INVENTION

1. Field of the Invention

This invention relates to a table saw, particularly to one provided with a circular-saw elevating and lowering device for securing unchangeable the gap between a circular saw and a separating plate so as to protect a user's hand from being hurt by the circular saw in operation of the table saw.

2. Description of the Prior Art

FIGS. 1 and 2 show a conventional circular saw 10, which includes a base 11, a table fixed on the base 11 and a saw base 12 pivotally connected to a table 111 in its inside. The saw base 12 is pivotally connected with a circular saw 121 fixed to extend partly on the table 111 for carrying out sawing action on a work. Further, a fan-shaped gear 122 is fixed at one side of the circular saw 121, engaged with and controlled by a worm 123 pivotally connected on the base 11. The fan-shaped gear 122 can be adjusted in its position so that the thickness of a work to be sawed off by the circular saw can be adjusted. At the same time, for keeping safety in operating the circular saw 10, a separating plate 124 is provided a little high behind the circular saw 121, extending on the table 111. Further, a protective cover 125 is provided to cover on the circular saw 121 and the separating plate 124 together, preventing a user from touching the circular saw 121.

However, when the worm 123 is adjusted for changing the position of the circular saw 121, the gap between the circular saw 121 and the separating plate 124 may be also changed accordingly. If the circular saw 121 is adjusted for the thickness of a work reduced, the gap between the circular saw 121 and the separating plate 124 may be increased. Then provided the protective cover 125 should be removed off, the separating plate 124 cannot function for protecting a user, possible to let the hand of a user to be caught in the gap between the circular saw 121 and the separating plate 124 and hurt by the circular saw 121.

### SUMMARY OF THE INVENTION

The circular-saw elevating and lowering device for a table saw in the invention consists of a main rod, a worm, and a moving up-and-down block. The main rod has a first end pivotally connected on a lower fixing member, and a main bevel gear fixed thereon. The worm is pivotally fitted between an upper fixing member and the lower fixing member, and a subordinate bevel gear is fixed on the worm, engaged with the main bevel gear. The moving up-and-down block has a threaded hole vertically for engaging with the worm and an upper end fixed with a separating plate located behind a circular saw unit. When the main rod is rotated, the worm is accordingly rotated to move up or down the moving up-and-down block, which then elevates or lowers the circular saw unit and the separating plate synchronously. Thus the separating plate always protects the circular saw unit from being touched by the hands of a user in operating the table saw, even if the circular saw unit is adjusted in its position,

### BRIEF DESCRIPTION OF DRAWINGS

This invention will be better understood by referring to the accompanying drawings, wherein:

FIG. 1 is a perspective view of a conventional circular saw;

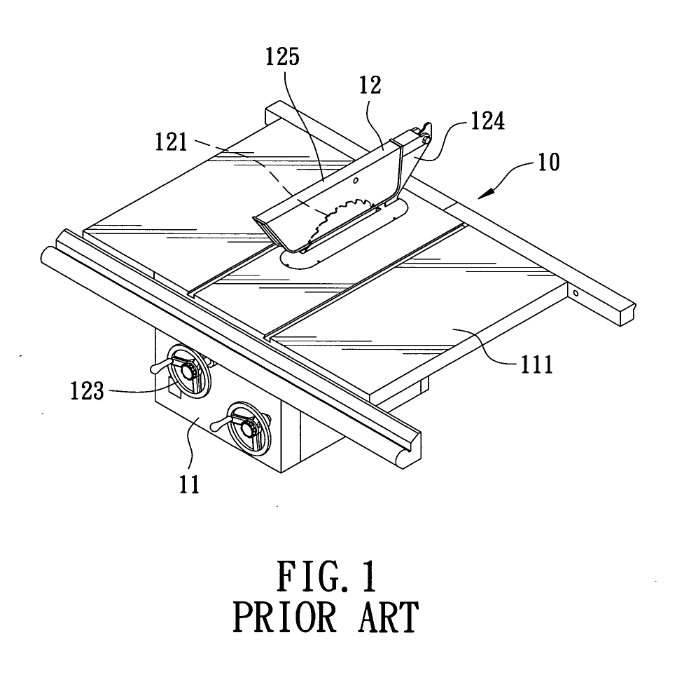

FIG. 2 is a partial perspective view of the conventional circular saw;

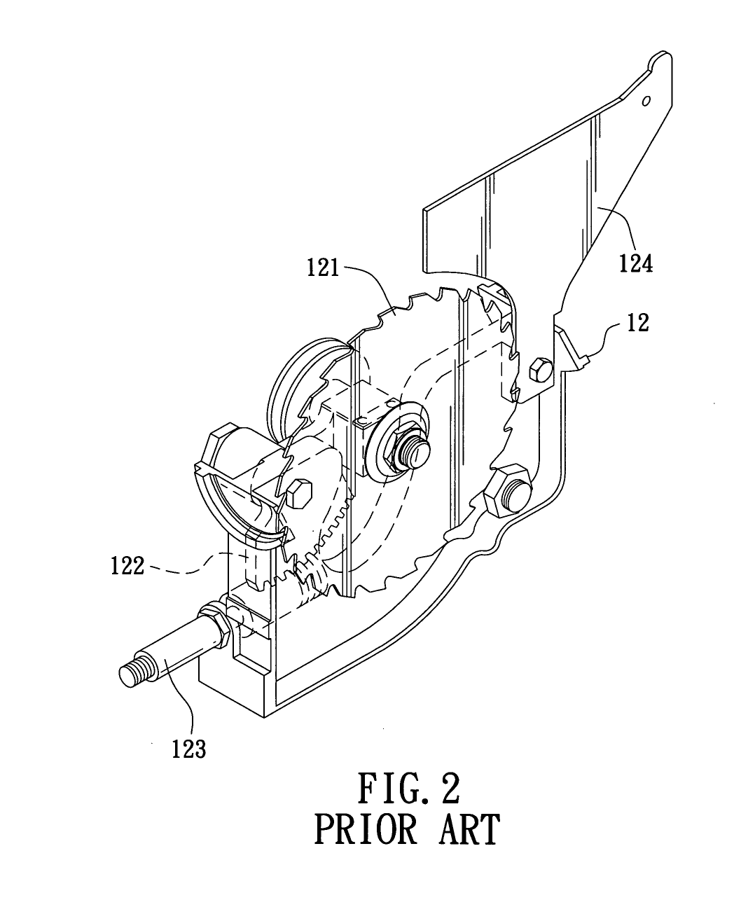

FIG. 3 is a perspective view of a table saw provided with a circular saw elevating and lowering device in the present invention;

FIG. 4 is an exploded perspective view of a circular saw elevating and lowering device and relative components for a table saw in the present invention;

FIG. 5 is a side view of the circular saw elevating and lowering device and the relative components for a table saw in the present invention;

FIG. 6 is a rear view of the circular saw elevating and lowering device with the relative components for a table saw in the present invention;

FIG. 7 is a side view of the circular saw elevating and lowering device with the relative components in the present invention, with the device being under elevating condition; and,

FIG. 8 is a cross-sectional view of a main rod in the present invention;

### DETAILED DESCRIPTION OF THE PREFERRED EMBODIMENT

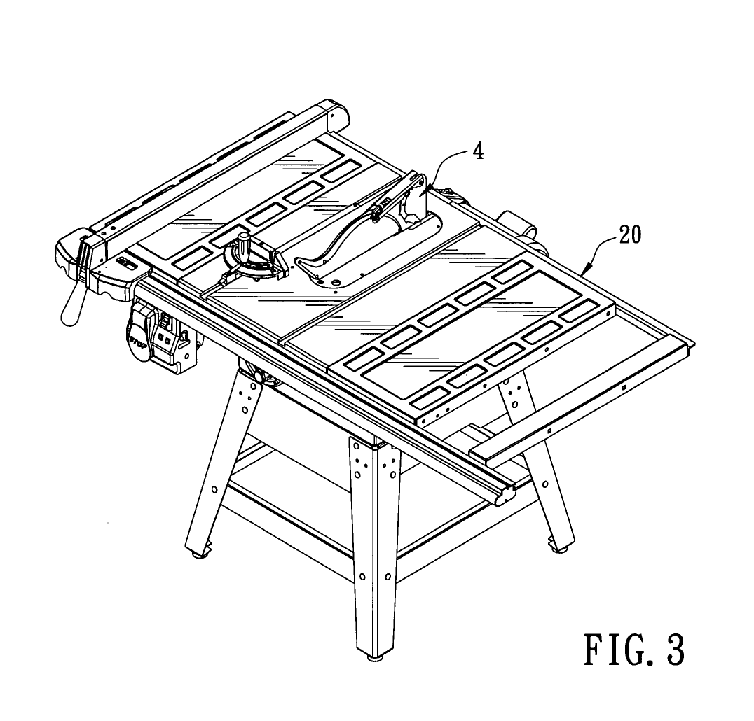

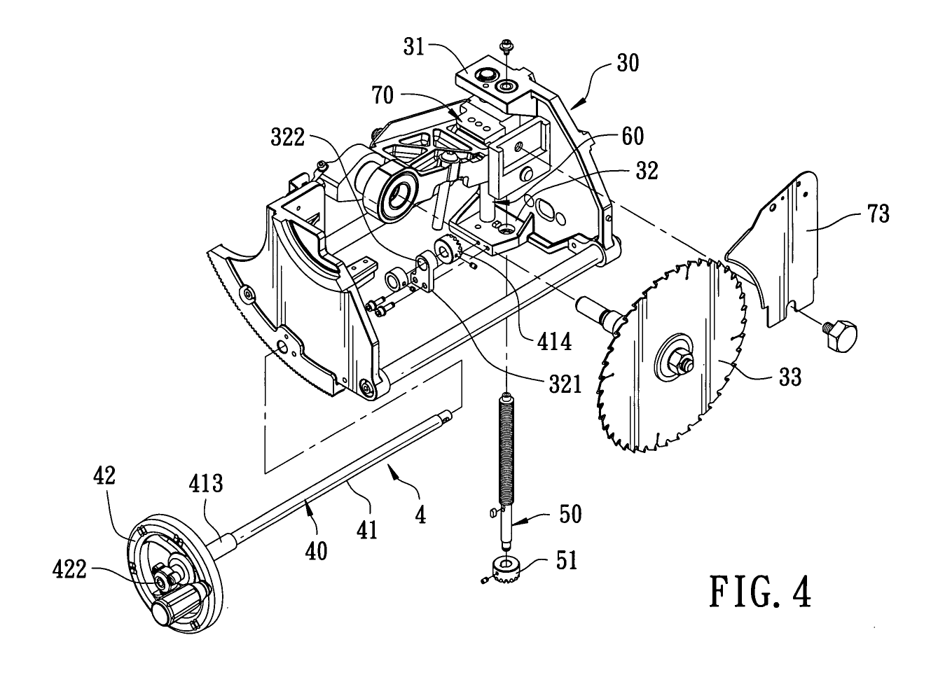

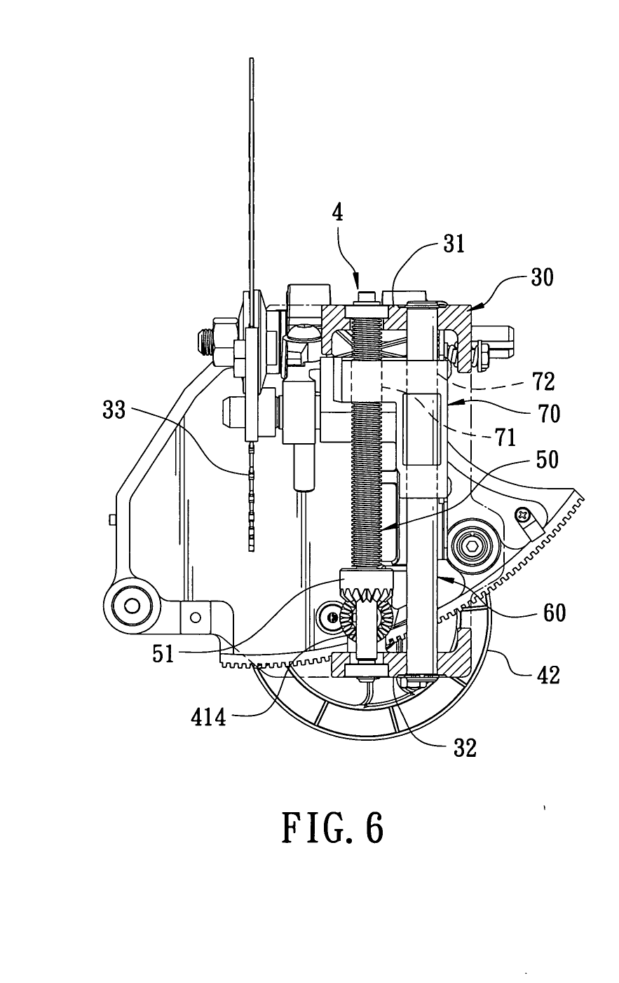

A preferred embodiment of a circular-saw elevating and lowering device 4 for a table saw, as shown in FIGS. 3, 4, 5 and 6, includes a main rod 40, a worm 50, a slide rod 60 and a moving up and down block 70. The table saw includes a base 20, a saw base 30 pivotally connected in the base 20, an upper fixing member 31, a lower fixing member, and a circular saw unit 33.

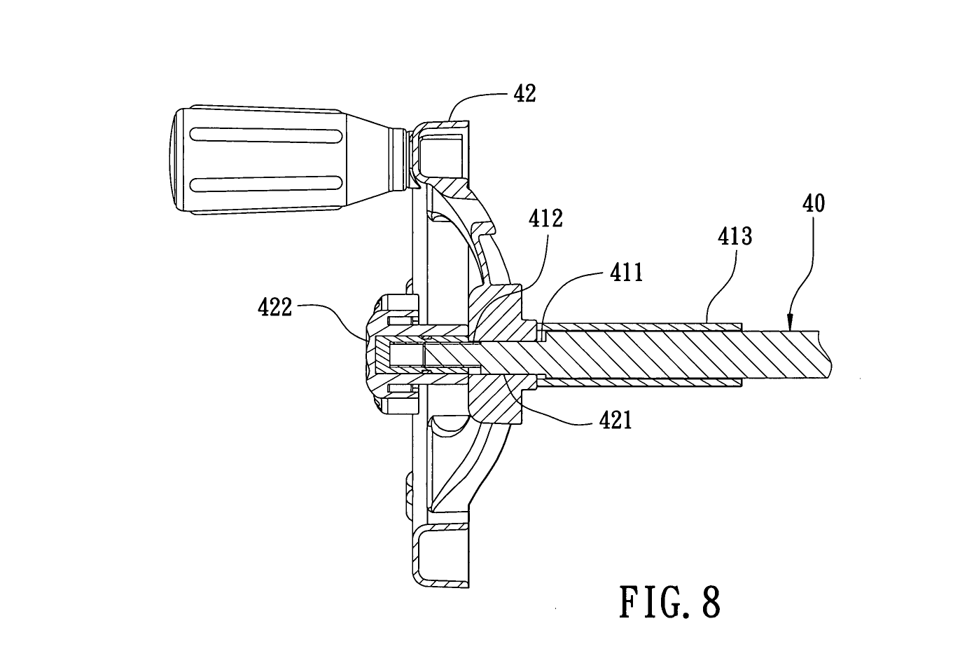

The main rod 40 is composed of an elongate rod 41 and a circular handle 42 as shown in FIG. 8, and the elongate rod 41 has its front end extending out of the base 20, a threaded front end portion 412, a fitting portion 411 just behind the threaded front end 411, and a sleeve 413 fitting around the portion at an outer side of the saw base 30 and the fitting portion 412. The rear end of the elongate rod 41 supported in the position hole 322 of the lower fixing member 321 is fixed with a main bevel gear 414. The circular handle 42 has a center hole 421 fitting tightly around the fitting portion 411 so the elongate rod 41 can be rotated by the circular handle 42. Further a tightening button 422 is threadably combined with the threaded end portion 412.

The worm 50 has two ends pivotally connected respectively with the upper fixing base 31 and the lower fixing base 30, located vertical to the main rod 40, and its lower end fixed with a subordinate gear 51, which then engages with the main bevel gear 414.

The slide rod 60 is positioned in parallel to the worm 50 and also between the upper and the lower fixing base 31 and 32

The moving up-and-down block 70 is provided with a threaded hole 71 for the worm 50 to engage and a through hole 72 for the slide rod 60 to pass through. Further a separating plate 73, located a little up behind the circular saw unit 33, is fixed on one side of the moving up-and-down block 70, and the circular saw unit 33 is pivotally connected to the front end of the moving up-and-down block 70.

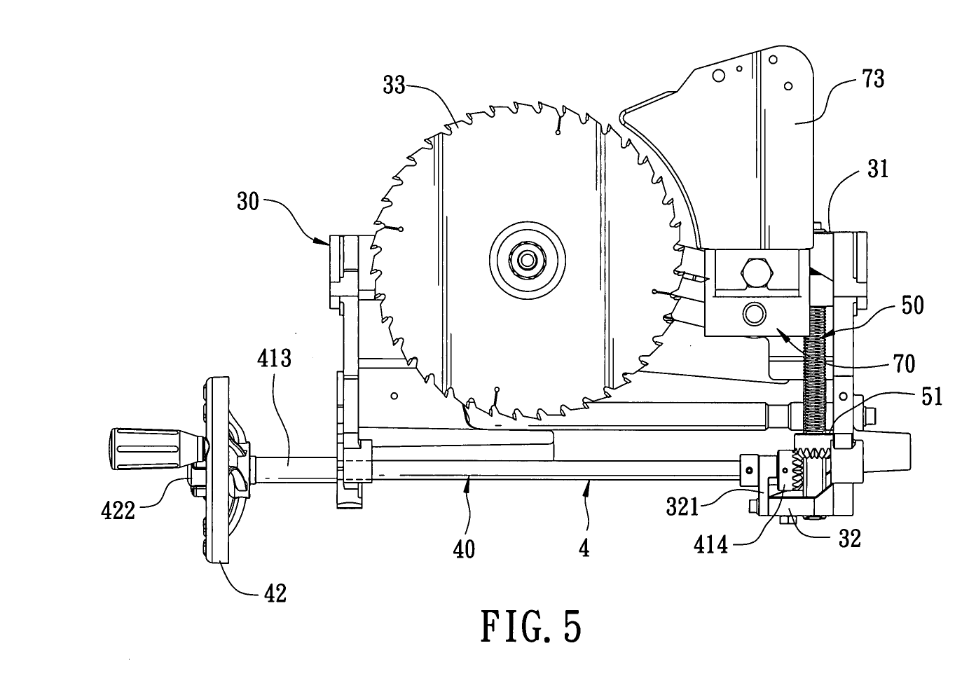

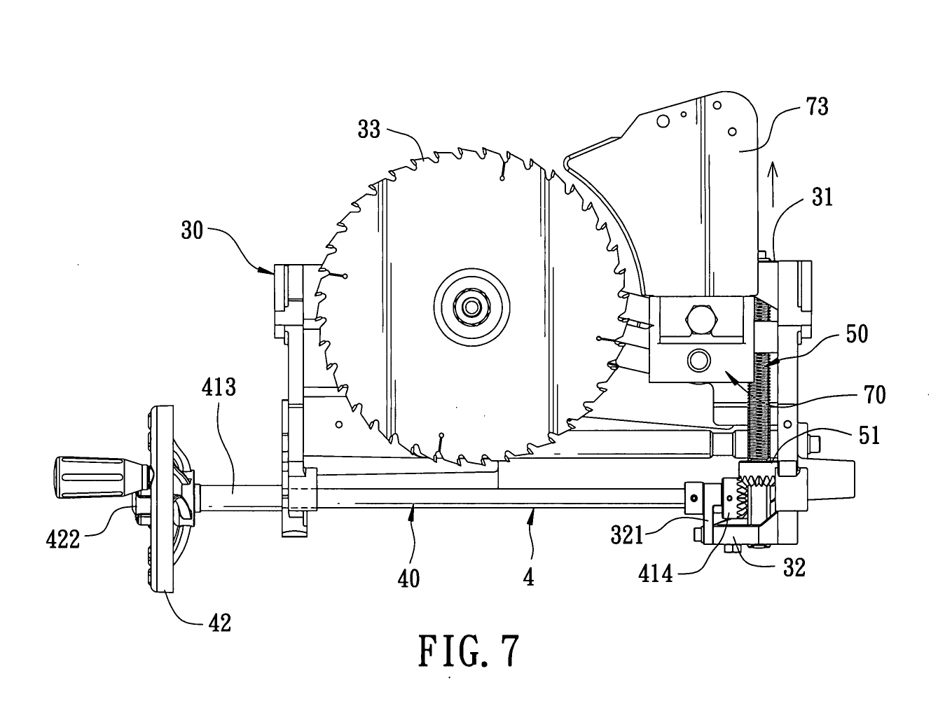

Next, referring to FIGS. 5 and 7, when the circular saw unit 33 is to be adjusted for the thickness of a work to be sawed, the circular handle 42 of the main rod 40 is to be rotated manually to rotate the main bevel gear 414, which then rotates the subordinate bevel gear 51 so that the moving up-and-down block 70 may be moved up or down by the distance caused by the rotation of the worm 50, elevating or lowering both the circular saw unit 33 and the separating plate 73 synchronously. Thus the gap between the circular saw unit 33 and the separating plate 73 is kept always the same, avoiding potential risk of the gap expanded to let the hands of a user hurt by the circular saw rotating by touching the circular saw 33.

In addition, it is worth to mention that after the main rod 40 is finished in adjustment, in order to avoid the circular handle 42 from rotated by some external force, the tightening button 422 can be rotated to let the circular handle 42 tightened by both the sleeve 413 and the tightening button 422, as shown in FIG. 8.

Lastly, the advantages of the invention are described as follows.
1. The circular saw elevating and lowering device can permit both the circular saw and the separating plate synchronously move up and down so the gap between the both can be maintained always the same, avoiding a user from hurt by the circular saw unit in sawing process and upgrading the safety in operating the table saw.
2. The circular saw elevating and lowering device has the circular handle fixed on the main rod, which can be controlled by the tightening button to be kept immovable, beefing up its fixedness for increasing convenience of assemblage and maintenance of the table saw.

While the preferred embodiment of the invention has been described above, it will be recognized and understood that various modifications may be made therein and the appended claims are intended to cover all such modifications that may fall within the spirit and scope of the invention.

What is claimed is:

1. A circular-saw elevating and lowering device for a table saw, said table saw having a base and a saw base pivotally connected inside said base, a circular saw unit pivotally connected in said saw base, an upper fixing member and a lower fixing member provided respectively to extend from an upper end and a lower end of a rear side of said saw base, said device combined between said upper fixing member and said lower fixing member, said device comprising:
A main rod composed of an elongate rod and a circular handle fixed at a first end of said elongate rod and pivotally connected to an outer side of said base, a second end of said elongate rod pivotally connected on said lower fixing member, a main bevel gear fixed on said lower end on said lower fixing member;
A worm pivotally connected between said upper and said lower fixing member, said worm having its lower end fixed with a subordinate bevel gear engaging with said main bevel gear; and,
A moving up-and-down block having a first side fixed with a separating plate located a little high behind said circular saw unit, said block having its front end pivotally connected to said circular saw unit, said block provided with a threaded hole for engaging with said worm and a through hole in parallel to said threaded hole for a slide rod to pass through.

2. The circular-saw elevating and lowering device for a table saw as claimed in claim 1, wherein said rod is provided with a sleeve between said saw base and said circular handle, and a fitting portion in an outer end and a threaded portion just in front of said fitting portion, with a tightening button engaged with said threaded portion.

3. The circular-saw elevating and lowering device for a table saw as claimed in claim 1, wherein said worm and said slide rod are positioned in parallel between said upper fixing member and said lower fixing member,

4. The circular-saw elevating and lowering fixing device for a table saw as claimed in claim 1, wherein said lower fixing member has a free end fixed with a position base, which has a position hole for pivotally connected to said main rod.
